(19) United States
(12) Patent Application Publication
(10) Pub. No.: US 2024/0305994 A1
(43) Pub. Date: Sep. 12, 2024

(54) METHODS, INFRASTRUCTURE EQUIPMENT AND COMMUNICATIONS DEVICES

(71) Applicant: Sony Group Corporation, Tokyo (JP)

(72) Inventors: Vivek SHARMA, Basingstoke (GB); Hideji WAKABAYASHI, Basingstoke (GB); Yassin Aden AWAD, Basingstoke (GB); Yuxin WEI, Basingstoke (GB)

(73) Assignee: Sony Group Corporation, Tokyo (JP)

(21) Appl. No.: 18/272,807

(22) PCT Filed: Jan. 4, 2022
(86) PCT No.: PCT/EP2022/050096

§ 371 Date: Jul. 18, 2023

(30) Foreign Application Priority Data
Feb. 5, 2021 (EP) 21155607.1

(51) Int. Cl. H04W 16/02; H04W 12/03; H04W 28/02; H04W 92/10

(52) U.S. Cl. CPC H04W 16/02; H04W 12/03; H04W 28/0273; H04W 92/10

(57) ABSTRACT

An infrastructure equipment forms a wireless access point of a wireless communications network and executes program code that performs a plurality of processes which form a protocol stack for providing, in combination with a radio equipment, a wireless access interface of the wireless communications network for transmitting data to or receiving data from one or more communications devices. The plurality of processes provide at least a physical, PHY, layer, a medium access control, MAC, layer, a radio link control, RLC layer, a scheduler and radio resource management for the wireless access interface which together form baseband functions. The infrastructure equipment is configured to transmit/encrypt and receive/decrypt packet data. An infrastructure equipment can be shared between two wireless communications networks, which may be controlled by different operators. One or more of the plurality of processes may also be encrypted.

### BACKGROUND

### Field of Disclosure

The present disclosure relates to communications devices, infrastructure equipment and methods of operating by a communications device in a wireless communications network. The present disclosure claims the Paris Convention priority from European patent application EP21155607.1, the content of which is incorporated by reference in its entirety into this disclosure.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Latest generation mobile telecommunication systems, such as those based on the 3GPP defined UMTS and Long Term Evolution (LTE) architecture as well as 5G/NR architectures, are able to support a wider range of services than simple voice and messaging services offered by previous generations of mobile telecommunication systems. For example, with the improved radio interface and enhanced data rates provided by LTE and 5G systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Future telecommunications networks may include various hardware and software items which are used to interconnect a range of devices via different types of network equipment and services. The ITU has been developing a vision for telecommunications in 2030 and has published a document [1](https://www.itu.int/en/ITU-T/focusgroups/net2030/Documents/Network_2030_Architecture-framework.pdf) which outlines future network technologies which provide interconnection of different types of communications devices such as drones, vehicles and mobile devices which may be configured to communicate via different types of networks and network entities such as terrestrial and non-terrestrial networks virtualised and non-virtualised networks, cloud storage and computing devices etc. A virtualised network is known as a network which is formed by combining hardware and software network resources and network functionality into a single, software-based administrative entity, known as a virtual network. Network virtualization involves platform virtualization, often combined with resource virtualization, which means that software application or application interfaces are running on top of a protocol stack which allows the network to exist as a single entity even though at lower protocol layers may be formed from different networks, network entities and hardware devices.

A vision identified for Network 2030 is to provide ubiquitous communications including increased resilience, packet by packet load balancing, zero packet loss, lower latency, tighter timing synchronization, optical and quantum computing etc. According to future proposals communication of data packets between entities may be via different operator networks with virtual connections in which traffic passes through different virtual connections across different network providers. As such a service may travel through infrastructure managed/hosted by different operators/providers. Different operators could be different service providers, for example cloud services or hosting providers may provide cloud infrastructure for other operators.

In view of this there is expected to be a desire for future wireless communications networks, for example those which may be referred to as 5G or new radio (NR) systems/new radio access technology (RAT) systems, as well as future iterations/releases of existing systems, to efficiently support connectivity for a wide range of devices associated with different applications and different characteristic data traffic profiles and requirements using virtual networks.

### SUMMARY OF THE DISCLOSURE

The present disclosure can help address or mitigate at least some of the issues discussed above.

According to disclosed embodiments of the present technique there is provided a method of operating an infrastructure equipment forming a wireless access point of a wireless communications network. The method comprises performing a plurality of processes which form baseband functions for providing, in combination with a radio equipment, a wireless access interface of the wireless communications network for transmitting data to or receiving data from one or more communications devices. In respect of an example of a 5G wireless communications network the infrastructure equipment may be a distributed unit, which forms with the radio equipment a gNB. The plurality of processes provide at least one of a physical, PHY, layer, a medium access control, MAC, layer, a radio link control, RLC layer, of a protocol stack and a scheduler and radio resource management for the wireless access interface. The method comprises transmitting packet data according to one or more of the plurality of processes via an interface between the infrastructure equipment and the radio equipment, and receiving packet data from the radio equipment via the interface according to the one of more of the plurality of processes. The transmitting the packet data includes encrypting at least part of the packet data before transmission via the interface between the radio equipment and the infrastructure equipment, and the receiving the packet data includes decrypting at least part of the packet data which has been encrypted for transmission via the interface.

Embodiments of the present technique can provide an infrastructure equipment which is shared between two wireless communications networks, which may be controlled by different operators. The plurality of processes which form a scheduler and/or radio resource management function are baseband functions of a base station, which in 5G is a gNB. The gNB is formed from the baseband functions and the radio equipment which may be a transceiver processing unit or remote radio head, which provides radio frequency functions so that together with the baseband functions produce a wireless access interface of a cell of the wireless communications network. As such, whilst the radio equipment is controlled by a first operator, the infrastructure equipment hosting the baseband functions may be controlled by a second operator. By encrypting packet data transmitted from the infrastructure equipment via the interface between the radio equipment and the infrastructure equipment a proprietary configuration of the baseband functions of the first operator may be protected from the second operator. One or more of the plurality of processes may also be encrypted.

Embodiments of the present technique, which, in addition to methods of operating infrastructure, relate to methods of operating communications devices and infrastructure equipment, and circuitry for communications devices and infrastructure equipment, allow for more a secure hosting of baseband functions close to a radio network cell formed by the baseband functions with radio equipment.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 is a schematic representation of a communications path for data packets proving a service of a user of a communications device remote from a server in which the communications path includes a plurality of virtual networks;

FIG. 2 is a schematic representation of a parts and some aspects of a new radio or 5G access technology (RAT), which may be configured to operate in accordance with certain embodiments of the present disclosure;

FIG. 3 is a schematic block diagram illustrating an arrangement in which a 5G infrastructure equipment forming part of a radio network known as a gNB is formed from a DU and a CU;

FIG. 4 is a schematic representation of two communications paths for data packets between devices supported by two different wireless communications networks in which the two communications paths pass through the same distributed unit which is shared between operators of the two different wireless communications networks;

FIG. 5 is a schematic representation of parts which form one of the wireless communications networks of the example shown in FIG. 4, illustrating an arrangement of processes which form a protocol stack in respective entities and the distributed unit which is shared between operators of the two different wireless communications networks;

FIG. 6 is a schematic representation of parts which form another of the wireless communications networks of the example shown in FIG. 4, illustrating an arrangement of processes which form a protocol stack in respective entities and in which the shared distributed unit is adapted to encrypt processes or packet data units to provide security of the functions implemented by the processes according to example embodiments;

FIG. 7 is a schematic representation of Medium Access Control header field and MAC Packet Data Unit structure for uplink and downlink, parts of which may be ciphered according to example embodiments; and

FIG. 8 is a schematic representation of a ciphering circuit which may be adapted according to example embodiments of the present technique.

### DETAILED DESCRIPTION OF THE EMBODIMENTS

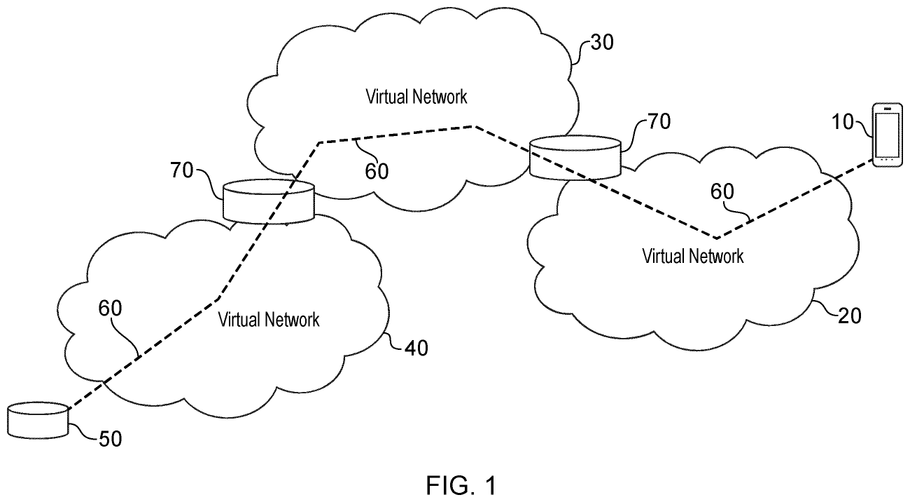

As shown in FIG. 1, a communications device 10 may be transmitting and receiving data via several virtual networks 20, 30, 40 to and from a device, which may be an application server 50, which may be providing a service to the communications device 10. As represented by a bold dashed line 60, the data packets may be communicated via the virtual networks 20, 30, 40 and via different gateways or servers 70, 80. As will be appreciated therefore the packets may be communicated to and from the communications device 10 from and to the server 50 via the virtual networks 20, 30, 40, and the servers 70, 80, which may be implemented using various technologies, which may be wired or wireless. However, as will be explained below, example embodiments concern communicating using wireless networks which form part of a communication path 60 to or from a communications device 10.

Although example embodiments find application with various types of wireless technologies, in one example a wireless communications network according to the 3GPP New Radio Access Technology/5G network may form a virtual network for communication packets to or from a communications device. An example of a 5G network is explained in the following paragraphs.

### New Radio Access Technology (5G)

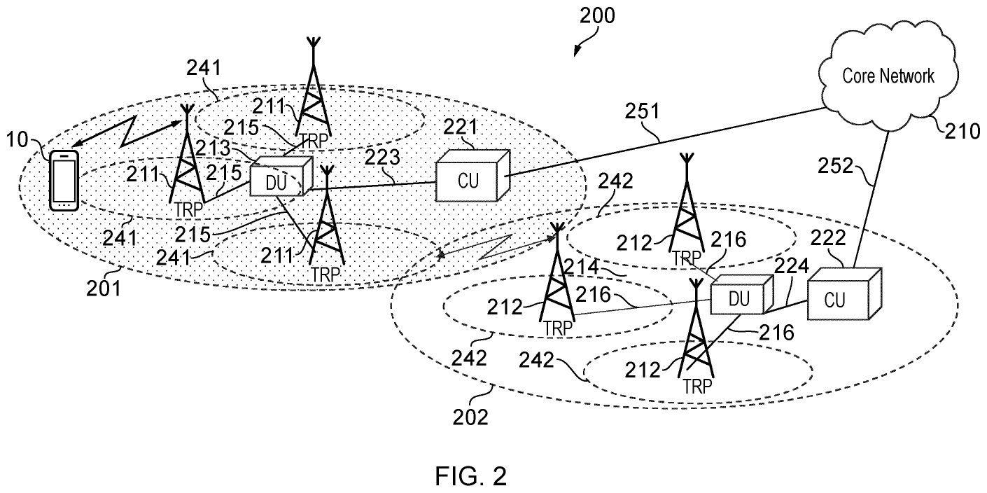

FIG. 2 is a schematic diagram illustrating a network architecture for a new RAT wireless communications network/system 200 based on previously proposed approaches which may also be adapted to provide functionality in accordance with embodiments of the disclosure described herein. The new RAT network 200 represented in FIG. 2 comprises a first communication cell 201 and a second communication cell 202. Each communication cell 201, 202, is formed by a plurality of transmission and reception points (TRPs) 211, 212 which are connected to distributed control units (DUs) 213, 214 by a connection interface represented as an interface 215, 216. Each of the DUs 213, 214 is connected to a respective central unit (CU) 221, 222 via an interface 223, 224 which together with the respective DU 213, 214 to which they are connected may be referred to as a controlling node. Each CU 221, 222 is then connected to the core network 210 which may contain all other functions required to transmit data for communicating to and from the wireless communications devices and the core network 210 may be connected to other networks.

The TRPs 211, 212 are responsible for providing the radio access interface for communications devices connected to the network. Each TRP 211, 212 has a coverage area (radio access footprint) 241, 242 where the sum of the coverage areas of the distributed units under the control of a controlling node together define the coverage of the respective communication cells 201, 202. Each TRP 211, 212 includes transceiver circuitry for transmission and reception of wireless signals and processor circuitry configured to control the respective TRP 211, 212.

In terms of broad top-level functionality, the core network component 210 of the new RAT communications network represented in FIG. 2 may be broadly considered to correspond with conventional core network, and the respective CU 221, 222 and DU 213, 214 and their associated distributed units/TRPs 211, 212 may be broadly considered to provide functionality corresponding to base stations or eNB or gNB of conventional networks. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs.

A communications device or UE 10 is represented in FIG. 2 within the coverage area of the first communication cell 201. This communications device 10 may thus exchange signalling with a first CU 221 in the first communication cell via one of the DU 213 associated with the first communication cell 201. In some cases, communications for a given communications device are routed through only one of the distributed units, but it will be appreciated in some other implementations communications associated with a given communications device may be routed through more than one distributed unit, for example in a soft handover scenario and other scenarios.

In the example of FIG. 2, two communication cells 201, 202 and one communications device 10 are shown for simplicity, but it will of course be appreciated that in practice the system may comprise a larger number of communication cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

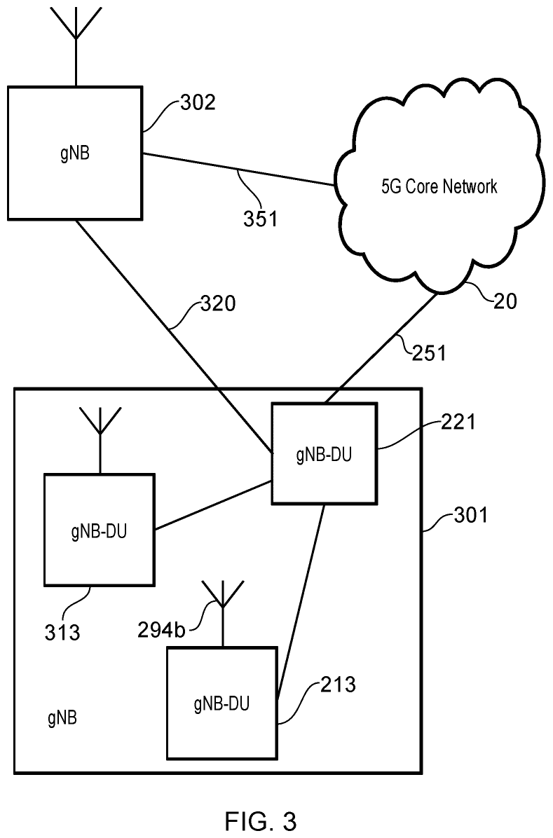

A further example deployment is shown in FIG. 3, which illustrates that in a 5G network, a CU 221 in combination with one or more DUs 213, 313 can form a base station or gNB 301 of a radio network part of the 5G radio access network (RAN). In FIG. 3, the example elements in the block diagram which are the same as those shown in FIG. 2 bear identical numerical designations. As shown in FIG. 3 a second gNB 302 is shown which is connected to a first gNB 301 formed from the CU 212 and the two DUs 213, 313 via an Xn-C interface 320. The Xn-C interface terminates at the CU 221 within the gNB 301.

One restriction of currently proposed architectures for 3GPP 5G is that a gNB-DU can only connect to a single CU. As such, in a private network deployment for example, an incumbent operator may be allocated a portion of the radio frequency spectrum and has so deploys a remote radio resource head RRH (antenna, RF) in order to serve the operator's users within a cell formed by the RRH. As those acquainted with wireless communications which appreciate an RRH, which can also be referred to as a remote radio unit (RRU) contains one or more antennas and radio frequency components and are sometimes used to extend coverage. The RRH maybe for example extended by fibre optic to baseband (BB) circuitry or other signal processing and operating parts which, with the RRH, forms a base station (BTS, NodeB, eNodeB) which for the example of 5G is a gNB. For example an operator may configure a 5G private network known as a stand-alone non-public network (SNPN) which may include one or more RRHs connected to baseband processing parts to form one or more gNBs.

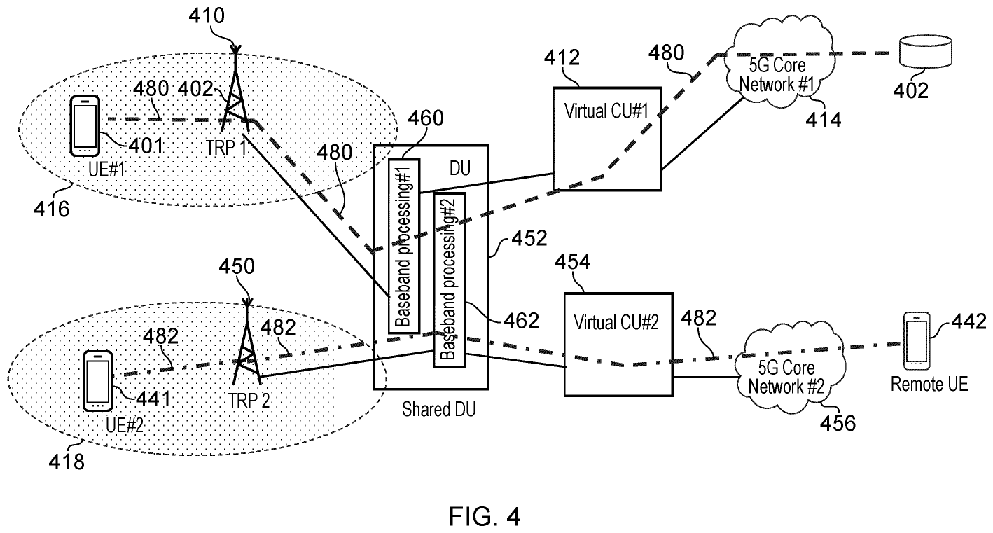

According to an example deployment, a first operator may have deployed an SNPN or home network with one or more RRHs. However due to a geographic location and/or a distribution of customers/users, the baseband circuitry or processing parts may be far from the RRH. As such a second operator/service provider may provide baseband processing capability to form with the first operator's RRH a gNB of an SNPN. In this scenario, the first operator would like to use the second operator's baseband processing circuitry. As a consequence, gNB-DU may connect to multiple operator RRH on a downstream of the network and multiple operators' gNB-CUs on the upstream of the network. In this deployment the first operator's RRH will connect to the second operator's baseband circuitry or DU and then connect to the first operator's CU. In such a configuration, an adaptation will be required of the 5G architecture as recited in TS 38.401 so that a DU can connect to more than one CU. An illustration is provided in FIG. 4.

In FIG. 4, a first UE #1 401 is communicating with a server 402 via a first wireless communications network operated by a first operator. A second UE #2 441 is communicating with another remote UE 442 via a second wireless communications network operated by a second operator. The first wireless communications network operated by the first operator comprises a TRP 410, which may include an RRH 410 which forms a wireless link with the first UE #1 401, a virtual CU #1 412 and a core network 414. The second wireless communications network operated by the second operator comprises a TRP/RRH 450, which forms a wireless link with the second UE #2 441, a DU 452, a virtual CU #2 454 and a core network 456. The TRP1 410 of the first operator's network forms, with baseband functions provided by the DU 452 a wireless access interface within a cell 416, whereas the TRP2 450 of the second operator's network forms, with baseband functions provided by the DU 452 a wireless access interface within a cell 418.

According to the example embodiment described below, the DU 452 of the second wireless communications network is shared between the first and second operators so that baseband processing for the first and the second wireless communications networks is implemented for the first and the second wireless communications networks by separate baseband processing 460, 462 for the first and second operators respectively. Accordingly a path of data packets 480 between the first UE #1 401 and the server 402 and a path of data packets 482 between the second UE #2 441 and the remote UE 442 formed by the second wireless communications network both pass through the DU 452 which is owned and operated by the second operator.

The baseband circuitry provided by a DU may include the functionality required to form a gNB, such as for example a scheduler which is a component of a base station/gNB which schedules transmission and allocation of resources on both the uplink and the downlink of the wireless access interface and also other Radio Resource Management operations. For the example scenario described above, then the first operator, which is sharing the second operator's DU may deploy its own scheduler which is implemented typically by software processing on the baseband processing circuitry of the second operator's DU. The first operator's data communications traffic will then go via the second operator's network. However, as will appreciated a scheduler for example may implement proprietary techniques which the first operator may not wish to disclose to the second operator which will be hosting the first operator's scheduler on its DU. Furthermore, the first operator's data communications traffic may include its customers/users confidential information. Currently, 5G security does not protect PHY signalling, medium access control (MAC) header information, MAC-control elements (MAC-CE), radio link control (RLC)-control packet data units (RLC-control PDU), packet data convergence protocol (PDCP) control PDUs and RLC and PDCP headers. This therefore can represent a technical problem.

Embodiments of the present technique can provide an infrastructure equipment forming a wireless access point of a wireless communications network. The infrastructure equipment includes a software controlled processor which executes program code which causes the infrastructure equipment to perform a plurality of processes which form baseband functions of a protocol stack for providing, in combination with a radio equipment, a wireless access interface of the wireless communications network for transmitting data to or receiving data from one or more communications devices. In respect of an example of a 5G wireless communications network the infrastructure equipment may be a distributed unit, which forms with the radio equipment a gNB. The infrastructure equipment may have an interface to more than one item of radio equipment each forming a cell of a different wireless communications network. The plurality of processes can provide at least one of a PHY, layer, a MAC, layer, a RLC layer, of a protocol stack, a scheduler and/or radio resource management for the wireless access interface of a cell. The method comprises transmitting packet data according to one or more of the plurality of processes via an interface between the infrastructure equipment and the radio equipment, and receiving packet data from the radio equipment via the interface according to the one of more of the plurality of processes. The transmitting the packet data includes encrypting at least part of the packet data before transmission via the interface between the radio equipment and the infrastructure equipment, and the receiving the packet data includes decrypting at least part of the packet data which has been encrypted for transmission via the interface.

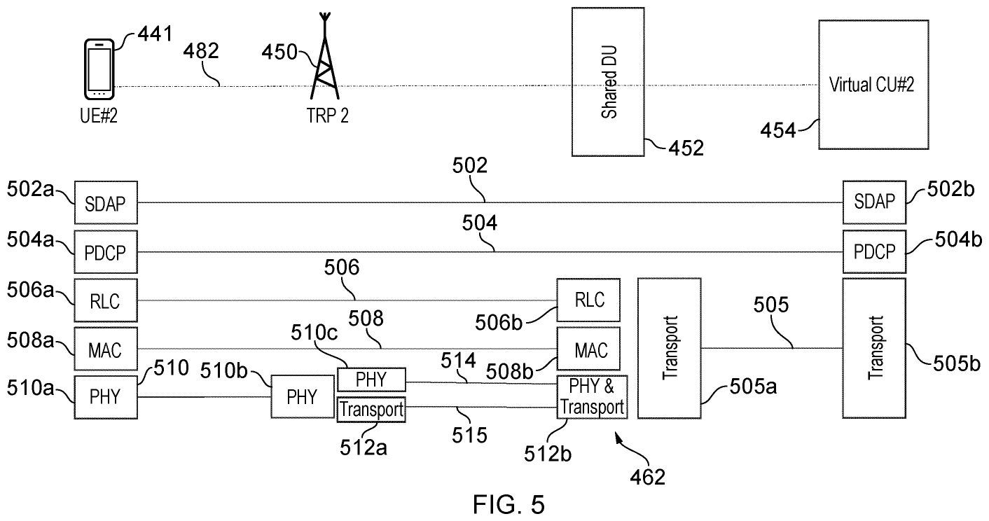

As mentioned above, a scheduler along with algorithms which provide a function for Radio Resource Management (RRM) can be considered as the “brain” of a base station and normally one of the main distinguishing factors between the offerings from different network vendors and operators. However, if the scheduler or RRM algorithms of a base station are shared with another operator or service provider then the operators may lose their competitive advantage. According to example embodiments therefore an arrangement is provided in which a sharing operator provides its own scheduler and RRM algorithms in a shared infrastructure equipment (DU) and at the same time secures packets as data communications traffic passing through the shared infrastructure equipment. In respect of a protocol stack, FIG. 5 provides an illustration of processing performed by the elements shown in FIG. 4 which form the packet data communications path 482 to and from the UE #2 441 by the second wireless communications network under the control of the second operator. As will be understood by those acquainted with the 5G Architecture, PDCP is a sublayer 504 in the protocol stack for communicating data between entities which receives/transmits network layer traffic (TCP/IP traffic). A Data Radio Bearer (DRB) is a logical connection used inside a 5G protocol stack to carry data packet data units (PDUs). A Service Data Adaptation Protocol (SDAP) 502 maps a quality of service (QoS) flow to and from a DRB at the PDCP sublayer 504 in both downlink and uplink directions. As shown in FIG. 5 therefore SDAP entities 502a, 502b in the UE #2 441 and the Virtual CU #2 454 respectively form an SDAP layer supported PDCP entities 504a, 504b forming the PDCP layer. Both the SDAP and the PDCP layers 502, 504 communicate data at these layers between the UE #2 441 and the Virtual CU #2 454. These layers 502, 504 are supported by operations of the TRP 2 450 and the shared DU 452. A transport layer 505 is formed by transport processors 505a, 505b between the Shared DU 452 and the Virtual CU #2 454.

A radio link control (RLC) layer 506a, 506b controls communication via the radio link 506 between the shared DU 452 and the UE #2 441, which is supported by a MAC sub-layer 508a, 508b. Data is communicated using the RLC and MAC sub-layers 506, 508 via a physical (PHY) layer 510a, 510b, 510c and a transport layer 512a, 512b formed in the shared DU 452 and the TRP #2 as a wired connection 515 and between the TRP #2 and the UE #2 441 as a radio connection 510 according to established techniques of for example a 5G radio access network.

As will be appreciated the TRP #2 450 includes a RRH as mentioned above and therefore includes antennas forming a part of the PHY layer 510 to transmit/receive RF signals and the rest of PHY layer including baseband processing, resource allocation etc. will be implemented in the DU 452. Transport between the TRP #2/RRH 450 and the shared DU 452 could be based on traditional interfaces like CPRI or e-CPRI or ethernet or similar. The RLC sub-layer 506, MAC sub-layer 508, and part of the PHY layer 510, the scheduler, and the RRM algorithms therefore virtually reside in the DU 452. The PDCP 504 and the SDAP 502 entities reside in the CU 454 and the UE #2 441.

A PDCP Control PDU can be used to convey the following information:
a PDCP status report; sent during Handover about missing packets in PDCP layer. If contents are changed then unnecessary retransmissions will take place in the target cell.
an interspersed ROHC feedback; if contents are changed then ROHC may not work
an EHC feedback: if contents are changed then Ethernet Header Compression won't work

The RLC sub-layer can communicate an RLC-Control packet data unit (PDU). This RLC-Control PDU can provide a status PDU, which can be used to indicate whether RLC data has been received successfully and lost data for RLC-Acknowledged Mode (AM) mode. If the contents are changed in the RLC-Control PDU then the RLC entity may retransmit packets which are already received, and the UE RLC layer may be out of sync and may perform re-establishment. PDCP/RLC control information does not disclose much information about the scheduler or RRM policies. However, as mentioned above, any tampering of this information can result in a degradation of service which is sometimes difficult to detect. If for example EHC feedback is compromised, then compression will not be initiated and missing Ethernet Header Compression (EHC) feedback may not trigger any alarm or may not exhibit abnormal behaviour, which may require additional monitoring to detect and cause overheads in transmission due to full header transmission despite EHC being configured and supported.

Similarly, MAC-Control Elements (MAC-CE) can also include (from TS 38.821) the following information the examples in bold representing information which may be particularly sensitive to a network operator:
SP CSI-RS/CSI-IM Resource Set Activation/Deactivation MAC CE;
Aperiodic CSI Trigger State Sub selection MAC CE;
TCI States Activation/Deactivation for UE-specific PDSCH MAC CE;
TCI State Indication for UE-specific PDCCH MAC CE;
SP CSI reporting on PUCCH Activation/Deactivation MAC CE;
SP SRS Activation/Deactivation MAC CE;
PUCCH spatial relation Activation/Deactivation MAC CE;
Enhanced PUCCH spatial relation Activation/Deactivation MAC CE;
SP ZP CSI-RS Resource Set Activation/Deactivation MAC CE;
Recommended Bit Rate MAC CE;
Enhanced SP/AP SRS Spatial Relation Indication MAC CE;
SRS Pathloss Reference RS Update MAC CE;
PUSCH Pathloss Reference RS Update MAC CE;
Serving Cell set based SRS Spatial Relation Indication MAC CE;
SP Positioning SRS Activation/Deactivation MAC CE;
Timing Delta MAC CE;
Guard Symbols MAC CEs.

Buffer Status Report (BSR) MAC CEs consist of either:
Short BSR format (fixed size); or
Long BSR format (variable size); or
Short Truncated BSR format (fixed size); or
Long Truncated BSR format (variable size).

Pre-emptive BSR MAC CE consists of:
Pre-emptive BSR format (variable size).
C-RNTI MAC CE

### SCell Activation/Deactivation MAC CE

Similarly, sensitive information may also be communicated via the PHY layer 510. For example, Downlink Control Information (DCI) messages which have between 40-60 bits and can carry different PHY layer control information such as resource allocation, MCS, coding rate are typically transmitted from the DU 452 to the TRP2/RRH 450 unprotected. These DCIs may be scrambled with C-RNTI. However, the C-RNTI is allocated in Random Access Response (RAR) message which is not PDCP security protected and can also be reallocated in C-RNTI MAC-CE above which is also unprotected. A Temporary C-RNTI is allocated in RAR and the UE assumes that the Temporary C-RNTI will be promoted to be the actual C-RNTI. The DCI, C-RNTI and RAR are therefore examples of information which is communicated via the PHY layer 514 between the DU 452 and the TRP2/RRH 452 and the MAC-CE may disclose information about the configuration of the scheduler and RRM policies, which could be deemed as important and might disclose a proprietary configuration of a scheduler/RRM information, which has been implemented by an operator. It will be appreciated however that the above are just examples of information, which, if compromised can be used to identify a configuration of a base station's scheduler in the broadest sense and or can cause disruption to an operator's network.

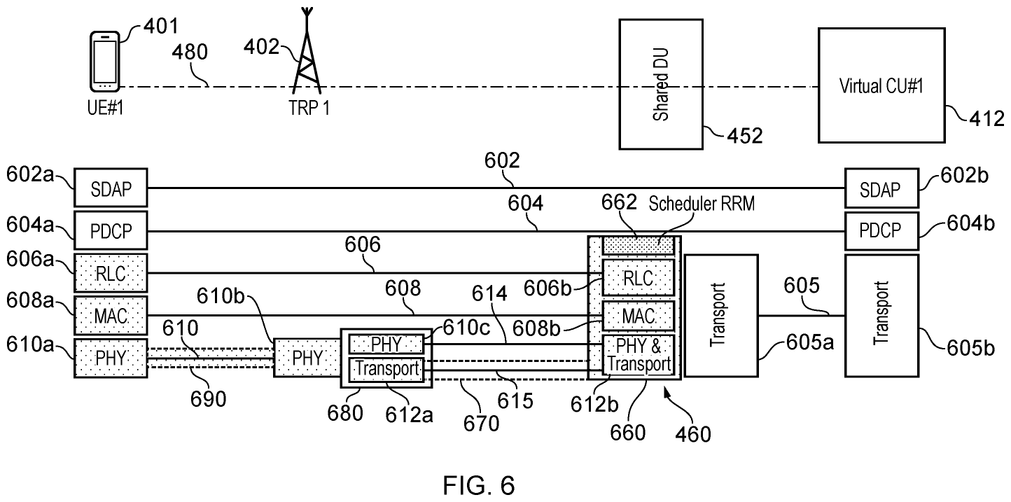

An example embodiment is shown in FIG. 6, which provides an illustration of components which form the first wireless communications network of FIG. 4, illustrating a protocol stack corresponding to that shown in FIG. 5. As shown in FIG. 6, components of the first wireless communications network are shown to support the communication of data packets via the first communication path 480 which includes the first Virtual CU #1, the shared DU 452, the TRP1/RRH 402 and the UE #1 401. As for the example of FIG. 5, an SDAP and a PDCP sub-layers 602, 604 are formed by processes 602a, 602b, 604a, 604b in the UE #1 401 and the Virtual CU #1 412. A radio link is formed by the RLC, MAC and PHY sub-layers 606, 608, 610 operating between the TRP1/RRH 402 and the UE #1 401 by processes/processors 606a, 608a, 610a, 606b, 608b, 610b operating in the UE #1 401 and the TRP1/RRH 402 respectively.

As for the example in FIG. 5, in the embodiment of FIG. 6 data is communicated via the wired link 614, 615 between the shared DU 452 and the TRP1/RRH 402 by PHY and Transport processors/processing 612b, 610c, 612a respectively.

According to the example embodiment shown in FIG. 6, the baseband processing forming the elements of the protocol stack in the shared DU 452, which form a gNB with the TRP 11/RRH 402 are encrypted as represented by a shaded box 660. That is to say that all of the processing/processors forming the RLC sublayer 606b, the MAC sublayer 608b and the PHY layer 612b are encrypted, although note that the transport layer 612b may have its own encryption and 3GPP does not define transport. Correspondingly in the TRP1/RRH 402, the PHY layer de-crypt messages and data received from the PHY layer 614 and the transport layer 615 as represented by a shaded box 680. Optionally therefore PDUs communicated between the TRP1/RRH 402 may be encrypted according a security tunnel 670, which may be implemented for example using IPSec. Furthermore, as explained below encryption or ciphering may be performed at the PHY layer 610 between the TRP1/RRH 402 and the UE #1 401 as represented by a security tunnel 690.

As illustrated by the example embodiment of FIG. 6, example embodiments address a technical problem of securing sensitive information whilst allowing processes according to a protocol stack which may be used to implement functions of a gNB to be hosted on another operator's or networks infrastructure equipment such as a DU. More generally an infrastructure equipment of a radio access network may be shared between network operators. Processors or processing which provides functions of a scheduler of RRM algorithms may be hosted on a shared infrastructure equipment.

In earlier 3GPP standards for 4G and 5G, security is performed in PDCP layer. In contrast for 3G standards a security function is implemented in the MAC layer. However, the MAC layer for 3G is centrally located in the Radio Network Controller. Another common aspect in previous standards is that the Access Stratum (AS) security is performed once only, because there is no concept of sharing equipment. However, example embodiments can perform another level of security between a shared infrastructure equipment on the network side which is closer to a customer's premises equipment and the UE.

An objective of sharing baseband processing resources as shown in FIGS. 3 and 5 is to reduce a latency for scheduling radio resources and a transport latency for communicating data packets. If, however, the sharing operator were to decide to run scheduler and RRM algorithms from a central location such as the virtual CU #1 454 in FIGS. 3 and 5 instead of hosting and executing these functions in the shared DU 452, this objective may not be met. However according to example embodiments a scheduler and RRM algorithms which with a TRP/RRH form a gNB are implemented according to a Service Function Chaining (SFC) as if hosted on another party's processor and for example providing a Service Level Agreement between two operators.

In this example embodiment two operators sharing an infrastructure are assumed. A cloud solution provider may provide physical infrastructure such as cloud servers which are closer to the subscriber or private network. Communications packet data may be IP tunnelled through IPSec or similar security tunnels between different network functions. Using encryption of baeband functions forming protocol stack processing require to form a gNB are encrypted to prevent a host or operator of the infrastructure equipment from eavesdropping on packet data being processed by the infrastructure equipment.

Even if a scheduler and RRM algorithms are secured in a place between two parties by encryption, a hosting operator can eavesdrop on the data packets themselves, so that there would be a risk of an operator, which uses a shared DU being exposed to a risk of losing proprietary information used/processed by the scheduler by for example inspecting Access Stratum (AS) layer protocol headers and PDCP/RLC/MAC/PHY control signalling because these headers/control signalling PDUs are not ciphered and integrity protected by an AS layer security. Access Stratum (AS) is known as a functional layer for transporting data between the UE and the radio network or access network, which also manages the radio resources. AS security therefore forms part of this layer, but is limited because the assumption in previous proposals that the security is associated with the user and is not needed for an operator's own network. So, there may be a need to protect the traffic passing through a shared infrastructure (within a node) beyond that provided by conventional AS security.

In a disclosure entitled “User Location Identification from Carrier Aggregation Secondary Cell Activation Messages”, GSMA Liaison Statement, 3GPP TSG RAN WG #2113-e there is a discussion on how a stealth attack can be launched to determine a number of secondary cells for a UE's based on a MAC layer message in carrier aggregation.

AS security key handling is specified in the PDCP layer and a scope of ciphering and integrity protection is specified in PDCP spec TS 38.323 (section 13). Sections 5.8 and 5.9 of TS 38.323 specify a ciphering function, which includes both ciphering and deciphering performed in PDCP layer if configured.

According this aspect of AS security data units that are ciphered are the MAC-I packets (see clause 6.3.4) and a data part of the PDCP Data PDU (see clause 6.3.3) except the SDAP header and the SDAP Control PDU if included in the PDCP SDU. The ciphering is not applicable to PDCP Control PDUs. The integrity protection function includes both integrity protection and integrity verification which is performed in the PDCP sub-layer, if configured, which integrity protects the PDU header and the data part of the PDU before ciphering. The integrity protection is applied to PDCP Data PDUs of Signalling Radio Bearers (SRBs). The integrity protection is applied to a sidelink SRB1, SRB2 and SRB3. The integrity protection is applied to PDCP Data PDUs of Dedicated Radio Bearers (DRBs) (including sidelink DRBs for unicast) for which integrity protection is configured. The integrity protection is not applicable to PDCP Control PDUs. As a result, according to current proposals a PDCP control PDU is neither ciphered nor integrity protected. The header part is not ciphered but may be integrity protected.

Lower layer (RLC, MAC) headers and control PDUs are not protected. Accordingly, example embodiments may be configured to include ciphering of MAC/RLC PDUs and/or integrity protection in MAC/RLC.

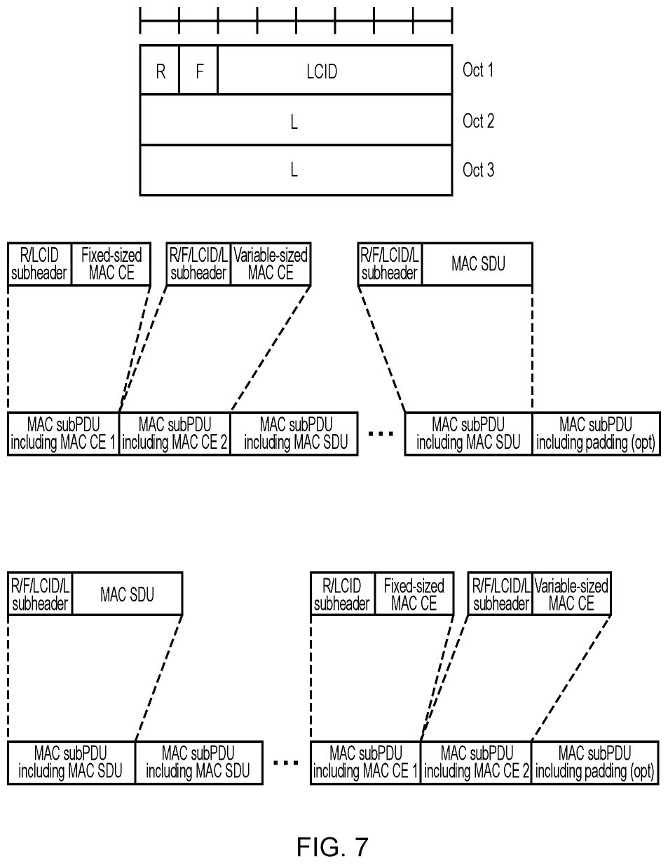

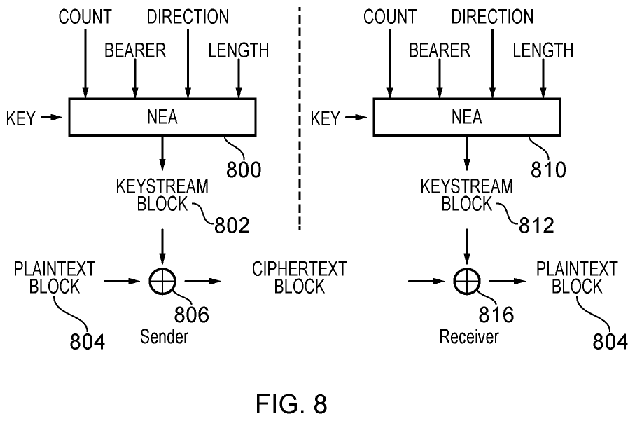

A diagram illustrating parts of MAC PDUs, illustrating a MAC header field and MAC PDU structure for uplink and downlink is provided in FIG. 7, which is derived from FIG. 6.1.2-4 of TS 38.323. For the example of MAC/RLC functional layers, ciphering is specified in section 5.8 of TS 38.323. For downlink and uplink ciphering and deciphering, the parameters that are required by PDCP for ciphering are defined in TS 33.501 and are input to a ciphering algorithm. An example of a ciphering algorithm according to existing AS security is shown in FIG. 8. The required inputs to a Network Authorisation, NEA, ciphering function 800 shown in FIG. 8 include a COUNT value, and a DIRECTION (direction of the transmission: set as specified in TS 33.501). These parameters are required by PDCP which are provided by upper layers TS 38.331 and include a BEARER (defined as the radio bearer identifier in TS 33.501, which is a value of a Radio Bearer identity −1 as in TS 38.331 [3]), and a KEY, which include ciphering keys for the control plane and for the user plane, which are K_{RRCenc} and K_{UPenc}, respectively. Annex D2 and D3 of TS 33.501 explains the relationship between COUNT, DIRECTION, BEARER, LENGTH and KEY, which are used to generate a network authentication cipher stream 802, using a stream cypher produced by the cypher function 800 from the inputs, which generates a keystream block 802 which is combined with a plain text 804 block for transmission by an XOR circuit 806. Correspondingly at a receiver the same cypher function 810 using the same inputs COUNT, DIRECTION, BEARER AND LENGTH and KEY generates a keystream block 812, which is combined by an XOR circuit combiner 816 which recovers the original plain text block 804.

According to example embodiments, ciphering and deciphering in lower layers can be configured with a number of input parameters which include COUNT (32 bit number), DIRECTION (direction of transmission), BEARER (identifier), and KEY. COUNT and DIRECTION and are the same as existing proposals. However, a new KEY is derived for lower layer ciphering/deciphering and an indication of a BEARER is adapted to be a Logical Channel ID (LCID) instead of a Radio Bearer ID. The Key is derived from KRRCenc and KUPenc by performing an operation like AND/OR/XOR with a newly defined counter value. The counter value is known to both ends in a secure way, according to PDUs transmitted by the lower layers. The payload is then encrypted in the transmitter and decrypted in the receiver.

In other embodiments, RLC PDUs are ciphered and deciphered instead of MAC PDUs. An RLC header does not include an LCID and so a bearer ID is used instead which could be either an LCID or a Radio Bearer (RB) ID.

In other embodiments, a COUNT parameter, which identifies the PDUs is replaced with a new counter maintained at lower layers for a counter of PDUs at these lower layers. This is because there is a security risk of sharing a PDCP COUNT value from a CU to a shared DU or a part of a DU. COUNT is therefore a 32 bit counter incremented with each PDU. The same count value is not reused with the same security parameters to avoid replay attacks.

In other embodiments, MAC transport blocks (TBs) may include MAC PDUs related to more than a single UE and uplink traffic may be combined in the RRH. According to this arrangement, ciphering may occur on a cell level or a tunnel is created between the RRH and the DU as illustrated by the shaded representation 670 shown in FIG. 6. RRH is therefore adapted to be more secure and the tunnel can be implemented using tunnel protocols such as for example IPSec.

As mentioned above, advantageously, some protection should be provided at the PHY layer. According to example embodiments a content of DCI message and similar physical layer signalling (e.g. SRS, DMRS, PUCCH) are also encrypted and/or integrity protected. The PHY layer is not aware of a BEARER or a COUNT value so these parameters may not be used. Instead, according to example embodiments a simple mechanism of generating the ciphering key by performing an operation between C-RNTI and KRRCenc key can be used as an example technique for providing some ciphering of the data in the DCI. However, this operation should not be a simple operation which can lead to revealing the KRRCenc key. The C-RNTI may be known to the attacker, but at the same time it is one of the important identifiers used in PHY layer signalling. Accordingly, the C-RNTI can be used as an input parameter for ciphering, for example the C-RNTI can be used as a sub-key derived from the KRRCenc key. A CU may pass this new key to the DU. The CU can also provide a mechanism/indication to derive the new key for the UE after PDCP security has been setup.

The example embodiments described for RLC/MAC encryption and integrity protection can also apply for PHY layer signalling protection because the information is available within the DU and inter layer coordination is possible. That is to say that the examples of ciphering and deciphering for the RLC and MAC layers can also be applied with the PHY layer. However, the PHY layer does not have access to COUNT in normal operation. For this example, the encryption is performed after PHY signalling is prepared and using parameters from an upper layer (calling this upper layer function in the PHY layer). On the receiver side the receiver will receive the PHY layer signalling but before it understands the PHY signalling, it must call a function of the upper layer before it can perform decryption.

Currently a bit-level scrambling is used for the bits in the DCI (i.e. the payload) where the scrambling generation is initialised with a value provided by RNTI (e.g. C-RNTI, RA-RNTI) and another ID (i.e. cell ID or a UE specific ID configured by RRC which is equivalent to the cell ID). By the same token, some scrambling is used for DMRS, SRS and PUCCH where the scrambling generation is initialised with some known parameters at the UE. In another embodiment, an additional parameter of KRRCenc key can be added to the function that generates the scrambling for DCI, DMRS, SRS and PUCCH.

As will be appreciated, if ciphering is performed in the PHY layer then deciphering is performed in the same layer 610, between UE 401 and the DU 452 in FIG. 6 as represented by a security tunnel 670, 690. Similarly, for messages and information ciphered at the MAC layer 608b and the RLC layer 606b and communicated via the protocol stack and the PHY layer 610 then at the UE 401 deciphering is performed at the corresponding MAC 608a and RLC 606a layers. As such messages and information are deciphered by the UE 401, so that if ciphering is performed in MAC/RLC layer then deciphering is performed in the same layer 606, 608. The same approach can be applied to integrity protection.

Correspondingly, although the UE 401 itself is considered secure by the first operator, any messages and information transmitted to the shared DU 452 via the TRP1 402 are ciphered by the respective RLC and MAC layers 606a, 608a and then deciphered at the shared DU 452 by corresponding protocol layers 606b, 608b. Furthermore, ciphering and deciphering may be performed at the PHY layer 610a and deciphered at the PHY layer 612b in the shared DU 612b. As mentioned above, ciphering/deciphering is typically already included over the wireless access interface between the UE #1 401 and the TRP1 402 between PHY layers processes 610a, 610b as a radio bearer. However additional ciphering/deciphering may be included to provide the secure tunnels 690, 670 between the PHY layer 610a in the UE 401 and the PHY/Transport layer 612b in the shared DU 452 via the PHY layers 610b, 610c in the TRP 1 402. As such the RLC, MAC and PHY layers 606a, 608a, 610a in the UE #1 401 are shown as shaded boxes to indicate that these layers are performing ciphering/deciphering with the corresponding processes performing the RLC, MAC and PHY layers 606b, 608b, 612b.

As will be appreciated any operation according to a protocol at a respective layer RLC, MAC, PHY 606a, 606b, 608a, 608b, 610a, 610b which is performing ciphering when transmitting messages or information to a corresponding operation for the protocol at the receiver for deciphering and correspondingly performs a deciphering operation when receiving messages or information from the corresponding protocol layer which has ciphered messages and information.

According to example embodiments a security function may also be run like Service Function Chaining so that a sharing operator has full control over a security mechanism. So effectively, Service function chaining (SFC) is required to provide a virtual box which is under the control of sharing operator and with no access to a hosting provider, which can run important functions like a scheduler, RRM algorithms and security functions inside a hardware owned/operated by a hosting provider. This secure box is provided by encryption and other techniques and represented by the box 666. Also shown in the secure box 660 is a scheduler and RRM 662 which forms the gNB between the TRP1 402 and the shared DU 452. The scheduler and RRM 662 are hosted within the secure box 660 as part SFC by the host of the shared DU, which is the second operator in this example.

In other example embodiment, enhanced security is provided to an operator using another operator's infrastructure equipment by encrypting/ciphering MAC headers, MAC-CE, RLC headers, RLC-Control PDUs, and PDCP control PDUs only. Other data and PDUs, such as user data and/or application data and/or PDCP payload) are not encrypted or integrity protected beyond that already applied by the sharing operator. In another embodiment, the MAC header is not encrypted or encryption is applied to RLC and PDCP header selectively.

In other example embodiments, MAC PDUs including user data and all headers and control signalling are encrypted/ciphered. However, user data will have double encryption and NAS signalling may have triple encryption (lower layers, RRC, NAS), which may be regarded as excessive. This will depend on an amount of sharing involved in a network and each security function will correspond to a particular threat.

In other example embodiments, not all deployments will require enhanced security. According to some example embodiments the security enhancements may be configurable by a network operator. Normally, all UEs shall support this feature because if network is vulnerable then UE support shall not be the blocking point. However, if a small number of UEs support this feature or network enabled this feature for small number of UEs then still the integrity of scheduler and RRM algorithms can be maintained. So, it may be an optional feature for a UE to support and might be linked to supporting certain services or based on UE radio conditions i.e. UEs in good radio condition are configured for enhanced security and may compensate for any packet loss over the radio resulting in corruption of data. For example, URLLC UE is an expensive UE and may support this feature or higher end UEs, which support high end band combinations/MIMO/PHY capabilities may support the feature of enhanced security.

According to the above description, it will be appreciated that embodiments can provide a method of communicating by a communications device via a wireless communications network. The method comprises
performing, by processing circuitry of the communication device a plurality of processes which form a protocol stack including a physical, PHY, layer, a medium access control, MAC, layer, and a radio link control, RLC layer, the PHY layer being formed in combination with transmitter circuitry and receiver circuitry for transmitting data to or receiving data from the wireless communications network via a wireless access interface,
transmitting packet data, by the transmitter circuitry, according to one or more of the plurality of processes via the wireless access interface to a transceiver equipment forming in combination with a distributed processing unit a wireless access point of the wireless communication network, the wireless access point performing a plurality of processes which form a protocol stack corresponding to the protocol stack of the communications device including a corresponding PHY layer, a MAC later and an RLC layer, and
receiving packet data by the receiver circuitry according to one or more of the plurality of processes of the protocol stack of the communications device transmitted via the wireless access interface from the transceiver equipment of the wireless access point. The transmitting the packet data includes encrypting at least part of the packet data before transmission, and the receiving the packet data includes decrypting at least part of the packet data which has been encrypted for transmission via the wireless access interface from the transceiver equipment of the wireless access point.

Embodiments can also provide an infrastructure equipment for forming a wireless access point of a wireless communications network, the infrastructure equipment comprising
processing circuitry for executing program code, which when executed performs a plurality of processes which form a protocol stack for providing, in combination with a radio equipment, a wireless access interface of the wireless communications network for transmitting data to or receiving data from one or more communications devices, the plurality of processes providing at least a physical, PHY, layer, a medium access control, MAC, layer, a radio link control, RLC layer, a scheduler and radio resource management for the wireless access interface which together form baseband functions,
transmitting packet data according to one or more of the plurality of processes via an interface between the infrastructure equipment and the radio equipment, and
receiving packet data from the radio equipment via the interface according to the one of more of the plurality of processes, wherein the transmitting the packet data includes encrypting at least part of the packet data before transmission via the interface between the radio equipment and the infrastructure equipment, and the receiving the packet data includes decrypting at least part of the packet data which has been encrypted for transmission via the interface.

Embodiments can also provide a communications device for transmitting data to and receiving data from a wireless communications network, the communications device comprising
processing circuitry for executing program code which when executed forms a plurality of processes which form a protocol stack including a physical, PHY, layer, a medium access control, MAC, layer, and a radio link control, RLC layer, the PHY layer being formed in combination with transmitter circuitry and receiver circuitry for transmitting data to or receiving data from the wireless communications network via a wireless access interface,
transmitter circuitry for transmitting packet data according to one or more of the plurality of processes via the wireless access interface to a transceiver equipment forming in combination with a distributed processing unit a wireless access point of the wireless communication network, the wireless access point performing a plurality of processes which form a protocol stack corresponding to the protocol stack of the communications device including a corresponding PHY layer, a MAC later and an RLC layer, and
receiver circuitry for receiving packet data according to one or more of the plurality of processes of the protocol stack of the communications device transmitted via the wireless access interface from the transceiver equipment of the wireless access point, wherein the transmitting the packet data includes encrypting at least part of the packet data before transmission, and the receiving the packet data includes decrypting at least part of the packet data which has been encrypted for transmission via the wireless access interface from the transceiver equipment of the wireless access point.

Embodiments can also provide an interface formed between an infrastructure equipment and a radio equipment including transmitter and receiver circuitry, the infrastructure equipment forming, in combination with the radio equipment a wireless access point of a wireless communications network, wherein packet data transmitted via the interface includes packet data at least part of which has been encrypted before transmission via the interface. The at least part of the encrypted packet data may comprise at least one of a ciphered PDCP control PDU and an ciphered SDAP control PDU. The at least part of the encrypted packet data may comprise at least one of a ciphered MAC PDU headers, MAC PDUs, and ciphered MAC control PDUs. The at least part of the encrypted packet data may comprise at least one of a ciphered header of RLC packet data units, PDUs, and ciphered RLC control PDUs. The at least part of the encrypted packet data may comprise control or signalling information which is ciphered.

Embodiments can also provide an interface formed between a communications device, the infrastructure equipment forming, in combination with radio equipment a wireless access point of a wireless communications network, wherein packet data transmitted via the interface includes packet data at least part of which has been encrypted before transmission via the interface. The at least part of the encrypted packet data may comprise at least one of a ciphered PDCP control PDU and an ciphered SDAP control PDU. The at least part of the encrypted packet data may comprise at least one of a ciphered MAC PDU headers, MAC PDUs, and ciphered MAC control PDUs. The at least part of the encrypted packet data may comprise at least one of a ciphered header of RLC packet data units, PDUs, and ciphered RLC control PDUs. The at least part of the encrypted packet data may comprise control or signalling information which is ciphered.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:

Paragraph 1. A method of operating an infrastructure equipment forming a wireless access point of a wireless communications network, the method comprising
performing a plurality of processes which form baseband function of a protocol stack for providing, in combination with a radio equipment, a wireless access interface of the wireless communications network for transmitting data to or receiving data from one or more communications devices, the plurality of processes providing at least a part of a physical, PHY, layer, a medium access control, MAC, layer, a radio link control, RLC layer, and a scheduler and radio resource management for the wireless access interface,
transmitting packet data according to one or more of the plurality of processes via an interface between the infrastructure equipment and the radio equipment, and
receiving packet data from the radio equipment via the interface according to the one of more of the plurality of processes, wherein the transmitting the packet data includes encrypting at least part of the packet data before transmission via the interface between the radio equipment and the infrastructure equipment, and the receiving the packet data includes decrypting at least part of the packet data which has been encrypted for transmission via the interface.

Paragraph 2. A method according to paragraph 1, wherein the wireless communications network is a first wireless communications network, and the infrastructure equipment is shared between the first wireless communications network and a second wireless communications network.

Paragraph 3. A method according to paragraph 1 or 2, wherein the first wireless communications network is operated by a first operator and the second wireless communications network is operated by a second operator which controls the infrastructure equipment and hosts the plurality of processes which form the baseband functions for providing, in combination with the radio equipment, the wireless access interface of a cell of the first communications network.

Paragraph 4. A method according to paragraph 1, 2 or 3, wherein the plurality of processes which form the baseband function is a first plurality of processes which form a first baseband function for the cell of the first communications network, and the method comprises
performing, by the infrastructure equipment, a second plurality of processes which form a second baseband function, which in combination with second radio equipment provide a second wireless access interface for a second cell of the second communications network.

Paragraph 5. A method according to paragraph 4, wherein the first of the plurality of processes are encrypted to perform the first baseband function secure from the second operator.

Paragraph 6. A method according to any of paragraphs 1 to 5, wherein the plurality of processes are configured to transmit PDCP packet data units, PDUs, and SDAP, service data units to the communications device, and the encrypting at least part of the packet data before transmission via the interface between the radio equipment and the infrastructure equipment comprises ciphering at least one of a PDCP control PDU and an SDAP control PDU.

Paragraph 7. A method according to any of paragraphs 1 to 5, wherein the plurality of processes are configured to receive PDCP packet data units, PDUs, and SDAP, service data units from the communications device, and the decrypting at least part of the packet data received from the communications device via the interface between the radio equipment and the infrastructure equipment comprises deciphering at least one of a PDCP control PDU and an SDAP control PDU.

Paragraph 8. A method according to any of paragraphs 1 to 5, wherein the encrypting at least part of the packet data before transmission via the interface between the radio equipment and the infrastructure equipment comprises ciphering at least one of a header of MAC packet data units, PDUs, and MAC control PDUs.

Paragraph 9. A method according to any of paragraphs 1 to 5, wherein the decrypting the at least part of the packet data which has been encrypted for transmission via the interface between the radio equipment and the infrastructure equipment comprises deciphering at least one of a header of MAC packet data units, PDUs, and MAC control PDUs of the received PDUs.

Paragraph 10. A method according to paragraph 8 or 9, wherein the ciphering or the deciphering the at least one of the header of MAC PDUs, and MAC control PDUs comprises ciphering or deciphering using a ciphering circuit configured with input parameters including one or more of a count of PDU number, a direction of transmission indicating uplink from the communications device or downlink towards the communications device, a logical channel identifier, LCID, and a key derived by performing a logical operation with a value of the counter of the PDU number.

Paragraph 11. A method according to any of paragraphs 1 to 5, wherein the encrypting at least part of the packet data before transmission via the interface between the radio equipment and the infrastructure equipment comprises ciphering at least one of a header of RLC packet data units, PDUs, and RLC control PDUs.

Paragraph 12. A method according to any of paragraphs 1 to 5, wherein the decrypting the at least part of the packet data which has been encrypted for transmission via the interface between the radio equipment and the infrastructure equipment comprises deciphering at least one of a header of RLC packet data units, PDUs, and RLC control PDUs of the received PDUs.

Paragraph 13. A method according to paragraph 11 or 12, wherein the ciphering or the deciphering the at least one of the header of RLC PDUs, and RLC control PDUs comprises ciphering or deciphering using a ciphering circuit configured with input parameters including one or more of a count, a direction of transmission indicating uplink from the communications device or downlink towards the communications device, a radio bearer identifier, and a key derived by performing a logical operation with a value of the counter of the PDU number.

Paragraph 14. A method according to any of paragraphs 1 to 5, wherein the encrypting the at least part of the packet data before transmission via the interface between the radio equipment and the infrastructure equipment comprises ciphering control or signalling information which is to be transmitted via the wireless access interface to the communications device.

Paragraph 15. A method according to paragraph 14, wherein the control or signalling information comprises at least one of downlink control information messages, DCI, demodulation reference symbols, DMRS, or synchronisation reference symbols, SRS.

Paragraph 16. A method according to any of paragraphs 1 to 5, wherein the decrypting the at least part of the packet data received from the communications device from the interface between the radio equipment and the infrastructure equipment comprises deciphering control or signalling information transmitted via the wireless access interface from the communications device.

Paragraph 17. A method according to paragraph 16, wherein the control or signalling information comprises uplink control information received from a physical uplink control channel, PUCCH.

Paragraph 18. A method according to any of paragraphs 1 to 17, wherein the transmitting the packet data according to the one or more of the plurality of processes via the interface comprises transmitting the packet data via one or both of a PHY layer interface and a transport layer interface between the infrastructure equipment and the radio equipment, and the receiving the packet data from the radio equipment comprises receiving the packet data via one or both of the PHY layer interface and the transport layer interface according to the one of more of the plurality of processes.

Paragraph 19. A method according to any of paragraphs 1 to 18, comprising
receiving a configuration for selectively encrypting packet data correspondingly associated with one of more of the plurality of processes before transmission via the interface between the radio equipment and the infrastructure equipment, and for selectively decrypting received packet data which has been encrypted for transmission via the interface correspondingly associated with corresponding ones of the plurality of processes.

Paragraph 20. A method according to any of paragraphs 1 to 19, wherein the infrastructure equipment forms a Distributed unit, DU, and the wireless communications network is configured according to a 5G standards.

Paragraph 21. A method according to paragraph 20, wherein the infrastructure equipment includes a second interface between the infrastructure equipment and another radio equipment forming a second cell of a second wireless communications network.

Paragraph 22. A method of communicating by a communications device via a wireless communications network, the method comprising
performing, by processing circuitry of the communication device a plurality of processes which form a protocol stack including at least part of a physical, PHY, layer, a medium access control, MAC, layer, and a radio link control, RLC layer, the PHY layer being formed in combination with transmitter circuitry and receiver circuitry for transmitting data to or receiving data from the wireless communications network via a wireless access interface,
transmitting packet data, by the transmitter circuitry, according to one or more of the plurality of processes via the wireless access interface to a transceiver equipment forming in combination with a distributed processing unit a wireless access point of the wireless communication network, the wireless access point performing a plurality of processes which form a protocol stack corresponding to the protocol stack of the communications device including a corresponding PHY layer, a MAC later and an RLC layer, and
receiving packet data by the receiver circuitry according to one or more of the plurality of processes of the protocol stack of the communications device transmitted via the wireless access interface from the transceiver equipment of the wireless access point, wherein the transmitting the packet data includes encrypting at least part of the packet data before transmission, and the receiving the packet data includes decrypting at least part of the packet data which has been encrypted for transmission via the wireless access interface from the transceiver equipment of the wireless access point.

Paragraph 23. A method according to paragraph 22, wherein the transmitted packet data includes PDCP packet data units, PDUs, and SDAP, service data units transmitted by the transmitter circuitry to the wireless access point, and the encrypting at least part of the packet data before transmission comprises ciphering at least one of a PDCP control PDU and an SDAP control PDU.

Paragraph 24. A method according to paragraph 22 or 23, wherein the received packet data includes PDCP packet data units, PDUs, and SDAP, service data units received from the wireless access point, and the decrypting at least part of the packet data received from the wireless access point comprises deciphering at least one of a PDCP control PDU and an SDAP control PDU.

Paragraph 25. A method according to any of paragraphs 22, 23 or 24, wherein the encrypting at least part of the packet data before transmission comprises ciphering at least one of a header of MAC packet data units, PDUs, and MAC control PDUs.

Paragraph 26. A method according to any of paragraphs 22 to 25, wherein the decrypting the at least part of the packet data which has been encrypted for transmission via the wireless access interface from the transceiver equipment of the wireless access point comprises deciphering at least one of a header of MAC packet data units, PDUs, and MAC control PDUs of the received PDUs.

Paragraph 27. A method according to paragraph 25 or 26, wherein the ciphering or the deciphering the at least one of the header of MAC PDUs, and MAC control PDUs comprises ciphering or deciphering using a ciphering circuit configured with input parameters including one or more of a count value, a direction of transmission indicating uplink from the communications device or downlink towards the communications device, a logical channel identifier, LCID, and a key derived by performing a logical operation with the count value.

Paragraph 28. A method according to any of paragraphs 22 to 27, wherein the encrypting at least part of the packet data before transmission via the wireless access interface to the transceiver equipment of the wireless access point comprises ciphering at least one of a header of RLC packet data units, PDUs, and RLC control PDUs.

Paragraph 29. A method according to any of paragraphs 22 to 28, wherein the decrypting the at least part of the packet data which has been encrypted for transmission via the interface between the radio equipment and the infrastructure equipment comprises deciphering at least one of a header of RLC packet data units, PDUs, and RLC control PDUs of the received PDUs.

Paragraph 30. A method according to paragraph 28 or 29, wherein the ciphering or the deciphering the at least one of the header of RLC PDUs, and RLC control PDUs comprises ciphering or deciphering using a ciphering circuit configured with input parameters including one or more of a count, a direction of transmission indicating uplink from the communications device or downlink towards the communications device, a radio bearer identifier, and a key derived by performing a logical operation with a value of the counter.

Paragraph 31. A method according to any of paragraphs 22 to 30, wherein the encrypting the at least part of the packet data before transmission via the wireless access interface from the transceiver equipment of the wireless access point comprises ciphering control or signalling information which is to be transmitted via the wireless access interface to the transceiver equipment of the wireless access point.

Paragraph 32. A method according to paragraph 31, wherein the control or signalling information comprises uplink control information received from a physical uplink control channel, PUCCH.

Paragraph 33. A method according to any of paragraphs 22 to 32, wherein the decrypting the at least part of the packet data received from the wireless access interface from the transceiver equipment of the wireless access point comprises deciphering control or signalling information transmitted via the wireless access interface from the transceiver equipment of the wireless access point.

Paragraph 34. A method according to paragraph 33, wherein the control or signalling information comprises at least one of downlink control information messages, DCI, demodulation reference symbols, DMRS, or synchronisation reference symbols, SRS.

Paragraph 36. A method according to any of paragraphs 22 to 34, comprising
receiving a configuration for selectively encrypting packet data correspondingly associated with one of more of the plurality of processes before transmission via the interface between the radio equipment and the infrastructure equipment, and for selectively decrypting received packet data which has been encrypted for transmission via the interface correspondingly associated with corresponding ones of the plurality of processes.

Paragraph 37. An infrastructure equipment for forming a wireless access point of a wireless communications network, the infrastructure equipment comprising
processing circuitry for executing program code, which when executed performs a plurality of processes which form a protocol stack for providing, in combination with a radio equipment, a wireless access interface of the wireless communications network for transmitting data to or receiving data from one or more communications devices, the plurality of processes providing at least a physical, PHY, layer, a medium access control, MAC, layer, a radio link control, RLC layer, a scheduler and radio resource management for the wireless access interface which together form baseband functions,
transmitting packet data according to one or more of the plurality of processes via an interface between the infrastructure equipment and the radio equipment, and
receiving packet data from the radio equipment via the interface according to the one of more of the plurality of processes, wherein the transmitting the packet data includes encrypting at least part of the packet data before transmission via the interface between the radio equipment and the infrastructure equipment, and the receiving the packet data includes decrypting at least part of the packet data which has been encrypted for transmission via the interface.

Paragraph 38. A communications device for transmitting data to and receiving data from a wireless communications network, the communications device comprising
processing circuitry for executing program code which when executed forms a plurality of processes which form a protocol stack including a physical, PHY, layer, a medium access control, MAC, layer, and a radio link control, RLC layer, the PHY layer being formed in combination with transmitter circuitry and receiver circuitry for transmitting data to or receiving data from the wireless communications network via a wireless access interface,
transmitter circuitry for transmitting packet data according to one or more of the plurality of processes via the wireless access interface to a transceiver equipment forming in combination with a distributed processing unit a wireless access point of the wireless communication network, the wireless access point performing a plurality of processes which form a protocol stack corresponding to the protocol stack of the communications device including a corresponding PHY layer, a MAC later and an RLC layer, and
receiver circuitry for receiving packet data according to one or more of the plurality of processes of the protocol stack of the communications device transmitted via the wireless access interface from the transceiver equipment of the wireless access point, wherein the transmitting the packet data includes encrypting at least part of the packet data before transmission, and the receiving the packet data includes decrypting at least part of the packet data which has been encrypted for transmission via the wireless access interface from the transceiver equipment of the wireless access point.

Paragraph 39. An interface formed between an infrastructure equipment according to paragraph 37 and a radio equipment including transmitter and receiver circuitry, the infrastructure equipment forming, in combination with the radio equipment a wireless access point of a wireless communications network, wherein packet data transmitted via the interface includes packet data at least part of which has been encrypted before transmission via the interface.

Paragraph 40. An interface formed between a communications device according to paragraph 38 and an infrastructure equipment according to paragraph 37, the infrastructure equipment forming, in combination with radio equipment a wireless access point of a wireless communications network, wherein packet data transmitted via the interface includes packet data at least part of which has been encrypted before transmission via the interface.

Paragraph 41. Circuitry for an infrastructure equipment forming a wireless access point of a wireless communications network, the circuitry comprising
processing circuitry for executing program code, which when executed performs a plurality of processes which form a protocol stack for providing, in combination with a radio equipment, a wireless access interface of the wireless communications network for transmitting data to or receiving data from one or more communications devices, the plurality of processes providing at least a physical, PHY, layer, a medium access control, MAC, layer, a radio link control, RLC layer, a scheduler and radio resource management for the wireless access interface which together form baseband functions,
circuitry for transmitting packet data according to one or more of the plurality of processes via an interface between the infrastructure equipment and the radio equipment, and
circuitry for receiving packet data from the radio equipment via the interface according to the one of more of the plurality of processes, wherein the circuitry for transmitting the packet data includes circuitry for encrypting at least part of the packet data before transmission via the interface between the radio equipment and the infrastructure equipment, and the circuitry for receiving the packet data includes circuitry for decrypting at least part of the packet data which has been encrypted for transmission via the interface.

Paragraph 42. Circuitry for a communications device for transmitting data to and receiving data from a wireless communications network, the circuitry comprising
processing circuitry for executing program code which when executed forms a plurality of processes which form a protocol stack including a physical, PHY, layer, a medium access control, MAC, layer, and a radio link control, RLC layer, the PHY layer being formed in combination with transmitter circuitry and receiver circuitry for transmitting data to or receiving data from the wireless communications network via a wireless access interface,
transmitter circuitry for transmitting packet data according to one or more of the plurality of processes via the wireless access interface to a transceiver equipment forming in combination with a distributed processing unit a wireless access point of the wireless communication network, the wireless access point performing a plurality of processes which form a protocol stack corresponding to the protocol stack of the communications device including a corresponding PHY layer, a MAC later and an RLC layer, and
receiver circuitry for receiving packet data according to one or more of the plurality of processes of the protocol stack of the communications device transmitted via the wireless access interface from the transceiver equipment of the wireless access point, wherein the transmitting the packet data includes encrypting at least part of the packet data before transmission, and the receiving the packet data includes decrypting at least part of the packet data which has been encrypted for transmission via the wireless access interface from the transceiver equipment of the wireless access point.

Paragraph 43. Circuitry for an interface formed between an infrastructure equipment according to paragraph 37 and a radio equipment including transmitter and receiver circuitry, the infrastructure equipment forming, in combination with the radio equipment a wireless access point of a wireless communications network, wherein packet data transmitted via the interface circuitry includes packet data at least part of which has been encrypted before transmission via the interface circuitry.

Paragraph 44. Circuitry for an interface formed between a communications device according to paragraph 38 and an infrastructure equipment according to paragraph 37, the infrastructure equipment forming, in combination with radio equipment a wireless access point of a wireless communications network, wherein packet data transmitted via the interface circuitry includes packet data at least part of which has been encrypted before transmission via the interface circuitry.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] FG-NET2030 https://www.itu.int/en/ITU-T/focusgroups/net2030/Documents/Network_2030_Architecture-framework.pdf
[2] TS 38.323
[3] TS 33.501
[4] TS 38.331
[5] User Location Identification from Carrier Aggregation Secondary Cell Activation Messages”, GSMA Liaison Statement, 3GPP TSG RAN WG #2113-e

1. A method of operating an infrastructure equipment forming a wireless access point of a wireless communications network, the method comprising
performing a plurality of processes which form baseband function of a protocol stack for providing, in combination with a radio equipment, a wireless access interface of the wireless communications network for transmitting data to or receiving data from one or more communications devices, the plurality of processes providing at least a part of a physical, PHY, layer, a medium access control, MAC, layer, a radio link control, RLC layer, and a scheduler and radio resource management for the wireless access interface,
transmitting packet data according to one or more of the plurality of processes via an interface between the infrastructure equipment and the radio equipment, and
receiving packet data from the radio equipment via the interface according to the one of more of the plurality of processes, wherein the transmitting the packet data includes encrypting at least part of the packet data before transmission via the interface between the radio equipment and the infrastructure equipment, and the receiving the packet data includes decrypting at least part of the packet data which has been encrypted for transmission via the interface.

2. A method according to claim 1, wherein the wireless communications network is a first wireless communications network, and the infrastructure equipment is shared between the first wireless communications network and a second wireless communications network.

3. A method according to claim 1, wherein the first wireless communications network is operated by a first operator and the second wireless communications network is operated by a second operator which controls the infrastructure equipment and hosts the plurality of processes which form the baseband functions for providing, in combination with the radio equipment, the wireless access interface of a cell of the first communications network.

4. A method according to claim 1, wherein the plurality of processes which form the baseband function is a first plurality of processes which form a first baseband function for the cell of the first communications network, and the method comprises
performing, by the infrastructure equipment, a second plurality of processes which form a second baseband function, which in combination with second radio equipment provide a second wireless access interface for a second cell of the second communications network.

5. A method according to claim 4, wherein the first of the plurality of processes are encrypted to perform the first baseband function secure from the second operator.

6. A method according to claim 1, wherein the plurality of processes are configured to transmit PDCP packet data units, PDUs, and SDAP, service data units to the communications device, and the encrypting at least part of the packet data before transmission via the interface between the radio equipment and the infrastructure equipment comprises ciphering at least one of a PDCP control PDU and an SDAP control PDU.

7. A method according to claim 1, wherein the plurality of processes are configured to receive PDCP packet data units, PDUs, and SDAP, service data units from the communications device, and the decrypting at least part of the packet data received from the communications device via the interface between the radio equipment and the infrastructure equipment comprises deciphering at least one of a PDCP control PDU and an SDAP control PDU.

8. A method according to claim 1, wherein the encrypting at least part of the packet data before transmission via the interface between the radio equipment and the infrastructure equipment comprises ciphering at least one of a header of MAC packet data units, PDUs, and MAC control PDUs.

9. A method according to claim 1, wherein the decrypting the at least part of the packet data which has been encrypted for transmission via the interface between the radio equipment and the infrastructure equipment comprises deciphering at least one of a header of MAC packet data units, PDUs, and MAC control PDUs of the received PDUs.

10. A method according to claim 8, wherein the ciphering or the deciphering the at least one of the header of MAC PDUs, and MAC control PDUs comprises ciphering or deciphering using a ciphering circuit configured with input parameters including one or more of a count of PDU number, a direction of transmission indicating uplink from the communications device or downlink towards the communications device, a logical channel identifier, LCID, and a key derived by performing a logical operation with a value of the counter of the PDU number.

11. A method according to claim 1, wherein the encrypting at least part of the packet data before transmission via the interface between the radio equipment and the infrastructure equipment comprises ciphering at least one of a header of RLC packet data units, PDUs, and RLC control PDUs.

12. A method according to claim 1, wherein the decrypting the at least part of the packet data which has been encrypted for transmission via the interface between the radio equipment and the infrastructure equipment comprises deciphering at least one of a header of RLC packet data units, PDUs, and RLC control PDUs of the received PDUs.

13. A method according to claim 11, wherein the ciphering or the deciphering the at least one of the header of RLC PDUs, and RLC control PDUs comprises ciphering or deciphering using a ciphering circuit configured with input parameters including one or more of a count, a direction of transmission indicating uplink from the communications device or downlink towards the communications device, a radio bearer identifier, and a key derived by performing a logical operation with a value of the counter of the PDU number.

14. A method according to claim 1, wherein the encrypting the at least part of the packet data before transmission via the interface between the radio equipment and the infrastructure equipment comprises ciphering control or signalling information which is to be transmitted via the wireless access interface to the communications device.

15. A method according to claim 14, wherein the control or signalling information comprises at least one of downlink control information messages, DCI, demodulation reference symbols, DMRS, or synchronisation reference symbols, SRS.

16. A method according to claim 1, wherein the decrypting the at least part of the packet data received from the communications device from the interface between the radio equipment and the infrastructure equipment comprises deciphering control or signalling information transmitted via the wireless access interface from the communications device.

17. A method according to claim 16, wherein the control or signalling information comprises uplink control information received from a physical uplink control channel, PUCCH.

18. A method according to claim 1, wherein the transmitting the packet data according to the one or more of the plurality of processes via the interface comprises transmitting the packet data via one or both of a PHY layer interface and a transport layer interface between the infrastructure equipment and the radio equipment, and the receiving the packet data from the radio equipment comprises receiving the packet data via one or both of the PHY layer interface and the transport layer interface according to the one of more of the plurality of processes.

19.-36. (canceled)

37. An infrastructure equipment for forming a wireless access point of a wireless communications network, the infrastructure equipment comprising
processing circuitry for executing program code, which when executed performs a plurality of processes which form a protocol stack for providing, in combination with a radio equipment, a wireless access interface of the wireless communications network for transmitting data to or receiving data from one or more communications devices, the plurality of processes providing at least a physical, PHY, layer, a medium access control, MAC, layer, a radio link control, RLC layer, a scheduler and radio resource management for the wireless access interface which together form baseband functions,
transmitting packet data according to one or more of the plurality of processes via an interface between the infrastructure equipment and the radio equipment, and
receiving packet data from the radio equipment via the interface according to the one of more of the plurality of processes, wherein the transmitting the packet data includes encrypting at least part of the packet data before transmission via the interface between the radio equipment and the infrastructure equipment, and the receiving the packet data includes decrypting at least part of the packet data which has been encrypted for transmission via the interface.

38. A communications device for transmitting data to and receiving data from a wireless communications network, the communications device comprising
processing circuitry for executing program code which when executed forms a plurality of processes which form a protocol stack including a physical, PHY, layer, a medium access control, MAC, layer, and a radio link control, RLC layer, the PHY layer being formed in combination with transmitter circuitry and receiver circuitry for transmitting data to or receiving data from the wireless communications network via a wireless access interface,
transmitter circuitry for transmitting packet data according to one or more of the plurality of processes via the wireless access interface to a transceiver equipment forming in combination with a distributed processing unit a wireless access point of the wireless communication network, the wireless access point performing a plurality of processes which form a protocol stack corresponding to the protocol stack of the communications device including a corresponding PHY layer, a MAC later and an RLC layer, and
receiver circuitry for receiving packet data according to one or more of the plurality of processes of the protocol stack of the communications device transmitted via the wireless access interface from the transceiver equipment of the wireless access point, wherein the transmitting the packet data includes encrypting at least part of the packet data before transmission, and the receiving the packet data includes decrypting at least part of the packet data which has been encrypted for transmission via the wireless access interface from the transceiver equipment of the wireless access point.

39.-44. (canceled)
